(19) United States
(12) Patent Application Publication
(10) Pub. No.: US 2014/0251162 A1
(43) Pub. Date: Sep. 11, 2014

(54) FOOD PROCESSOR AND STEAM CHANNEL STRUCTURE THEREOF

(71) Applicant: Jianzhang Zhou, Anxiang (CN)

(72) Inventor: Jianzhang Zhou, Anxiang (CN)

(21) Appl. No.: 14/355,381

(22) PCT Filed: May 30, 2012
(86) PCT No.: PCT/CN2012/076291

§ 371 Date: Apr. 30, 2014

(30) Foreign Application Priority Data
Nov. 1, 2011 (CN) 201120425591.9

(51) Int. Cl. A47J 27/04

(52) U.S. Cl. CPC A47J 27/04; A47J 2027/043
USPC 99/403

(57) ABSTRACT

A food processor and a steam channel structure thereof. The food processor comprises a processor body (100), a steam generation device (200) and a heating cup (300). The heating cup is provided with a steam inlet (310) and a steam outlet (320); a steaming cup (400) is arranged in the heating cup; an air hole (410) is provided at a bottom wall of the steaming cup; a first gap (500) and a second gap (600) in communication with each other are respectively arranged between a side wall of the steaming cup and a side wall of the heating cup, and between the bottom wall of the steaming cup and a bottom wall of the heating cup; the steam channel has the following structure: a steam inflow channel is arranged in the first gap, and steam diffuses from the steam inlet on the heating cup towards two sides to enter the steam inflow channel, and enters the steaming cup through the air hole after entering the second gap from the steam inflow channel. The steam channel has a simple structure, a large steam flow, a short path, a little heat loss, and high heating efficiency.

### TECHNICAL FIELD

The present application relates to food processing equipment, more particularly, to an improved steam channel structure for the existing food processor.

### BACKGROUND

There are two types of food processors in prior art, one type is used for cooking food by electrical heating, the other type is for heating food by high temperature steam. The food processor of heating food by high temperature steam typically includes a processor body and a heating cup arranged thereon. The processor body includes a steam generator therein, and the steam produced by the generator generally goes into the heating cup body through the middle of the lid of the heating cup, then flows upward from the bottom of the cup body to heat the food, and finally discharges from the lid. In this structure, the steam flow has a long path, and a large heat loss, therefore the heating efficiency is low; the steam passes through the lid and the cup body twice, thereby both the lid and the cup body have a high temperature, as a result the user is in danger of being burned. So the structure of existing products does not meet the requirement of anti-scald and low carbon environmental requirements, so this type of products needs some improvement.

### SUMMARY OF THE INVENTION

One of the technical solutions to be solved by this application is to overcome the abovementioned defects by providing a steam channel structure for food processor, wherein this structure has a short steam path and high heating efficiency, and it is safer and more convenient to use.

To solve the above technical problem, the technical solution provided by this application is: a steam channel structure for food processor is provided, wherein the food processor comprises a processor body, a steam generator arranged in the processor body, and a heating cup disposed on the processor body, the heating cup has a vapor inlet interconnected with the steam generator and a vapor outlet, wherein the vapor inlet is disposed on the side wall of the heating cup, the heating cup includes a steaming cup therein, wherein the steaming cup has a gas pore on the bottom wall thereof, a first gap is arranged between the side wall of the steaming cup and the side wall of the heating cup, a second gap interconnected with the first gap is arranged between the bottom wall of the steaming cup and the bottom wall of the heating cup, a steam inflow channel corresponding to the steam inlet is arranged inside the first gap, the steam distributes on both sides of the inlet and flows into the inflow channel, then the steam passes through the second gap and flows into the steaming cup through the gas pore.

In particular, the steam inflow channel is enclosed by the side wall of the heating cup, the side wall of the steaming cup, a guide rib arranged between the two side walls and two isolation ribs located on both sides of the guide rib.

In particular, the guide rib faces the steam inlet; the guide rib has a shape of inverted U which comprises two branches, wherein each of the branches forms with the isolation ribs on both sides a left channel and a right channel for steam flow respectively; the top of the guide rib is lower than the steam inlet.

Furthermore, the guide rib is provided on the inner surface of the side wall of the heating cup or the outer surface of the side wall of the steaming cup, the isolation rib is arranged on the inner surface of the side wall of the heating cup or the outer surface of the side wall of the steaming cup.

Furthermore, the bottom of side wall of the steaming cup comprises a ring ribbon at the outer circumference for isolating the first gap from the second gap, wherein both ends of the ribbon are connected to the isolation ribs on both sides of the guide rib.

Furthermore, a lid is arranged on the heating cup, and an insulation plate is arranged at the inner side of the lid.

Furthermore, a curved convex pad is arranged on the inner side of the lid, and an insulation cavity is formed between the convex pad and the lid, and the insulation plate is disposed under the convex pad.

In order to solve the above problems, this application provides a technical solution as follows: a food processor is provided, wherein the food processor comprises the above said steam channel structure.

According to this application, the flow path of steam is distributed into two ways on both sides at first, then the steam goes downward into the steaming cup for heating the food. This structure is simple, and has a large steam flow and a short path, a low heat loss, high heating efficiency. The steam enters the bottom of the steaming cup through a specific steam inflow channel for heating food, and the contact area of the steam with the heating cup is small, thereby the scald to the user caused by the overheat of other portions of the side wall of the heating cup except the passage, so it is safer to use.

### BRIEF DESCRIPTION OF THE DRAWINGS

FIG. 1 is a structural schematic illustration of the food processor according to a preferred embodiment of this application.

FIG. 2 is a longitudinal sectional view of the food processor according to an embodiment of the present application, wherein the processor comprises a steam generator and a heating cup, and the processor body has been removed.

FIG. 3 is a transversal sectional view of the food processor according to an embodiment of this application.

FIG. 4 is an exploded view of the heating cup and the steaming cup according to an embodiment of this application.

### DETAILED DESCRIPTION OF THE INVENTION

Objects, advantages and embodiments of the present application will be explained below in detail with reference to the accompanying drawings and embodiments. However, it should be appreciated that the following description of the embodiment is merely exemplary in nature and is not intended to limit this application.

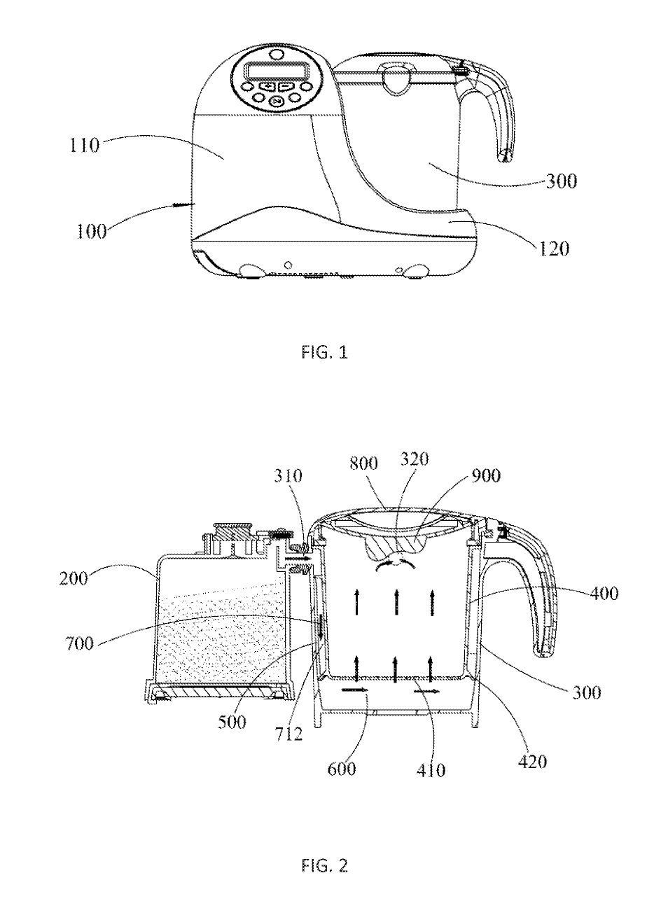

Referring to FIG. 1, it is a structural schematic illustration of the food processor according to a preferred embodiment of this application. The structure of the steam channel arranged inside a food processor will be explained in detail with reference to the following food processor as shown in this figure. However, it should be noted that the structure of the food processor is not limited within the structure shown in this figure, and a food processor, as long as it has the following steam channel structure, should be considered to be included within the scope of the present application.

With reference to FIGS. 2 to 4 again, the food processor comprises a processor body 100, a steam generator 200 arranged inside the processor body 100 and a heating cup 300 arranged on the processor body 100. In this embodiment, the processor body 100 comprises an upstanding main body 110 and a horizontal base 120 located on one side of the main body 110. The main body 110 includes an inner chamber (not shown), and the steam generator 200 is arranged inside the inner chamber, the heating cup is arranged on the base 120. In this structure, the heating cup 300 and the steam generator 200 are arranged side by side. The side wall of the heating cup 300 comprises a steam inlet 310 communicated with the steam generator 200, and the heating cup 300 contains a steaming cup 400 arranged therein, wherein the steaming cup 400 has a gas hole 410 on the bottom wall thereof. A steam outlet 320 is arranged on the side wall of the heating cup 300, and an exhaust port (not shown) corresponding to the steam outlet is provided on the side wall of the steaming cup 400. A first gap 500 is arranged between the side wall of the steaming cup 400 and the side wall of the heating cup 300, and a second gap 600 communicated with the first gap 500 is arranged between the bottom wall of the steaming cup 400 and the bottom wall of the heating cup 300, wherein the first gap 500 contains a steam inflow passage 700 corresponding to the steam inlet 310. Referring to FIG. 2, the steam flow paths are indicated by the arrows, the steam distributes on both sides of the steam inlet 310 and enters the steam inflow passage 700, then goes into the second gap 600, and into the steaming cup 400 through the gas hole 410. After heat exchange with the food inside the steaming cup 400, the steam discharges from the steam outlet 320. The steam outlet 320 is disposed on the side wall of the heating cup 300, in particular, in the use state, the steam outlet 320 is located behind the steam cup 400 facing the user, in this way, the burn to a user caused by the effluent steam can be avoided. The steam channel according to the present application has a simple structure, a short path, a low heat loss and high heating efficiency. The steam flows into the steaming cup 400 through a special steam inflow channel 700 for heating the food, comparing with the prior art, in this structure the contact area of the steam with the heating cup 300 is smaller, thereby the scald to the user caused by the overheat of the heating cup 300, so it is safer to use.

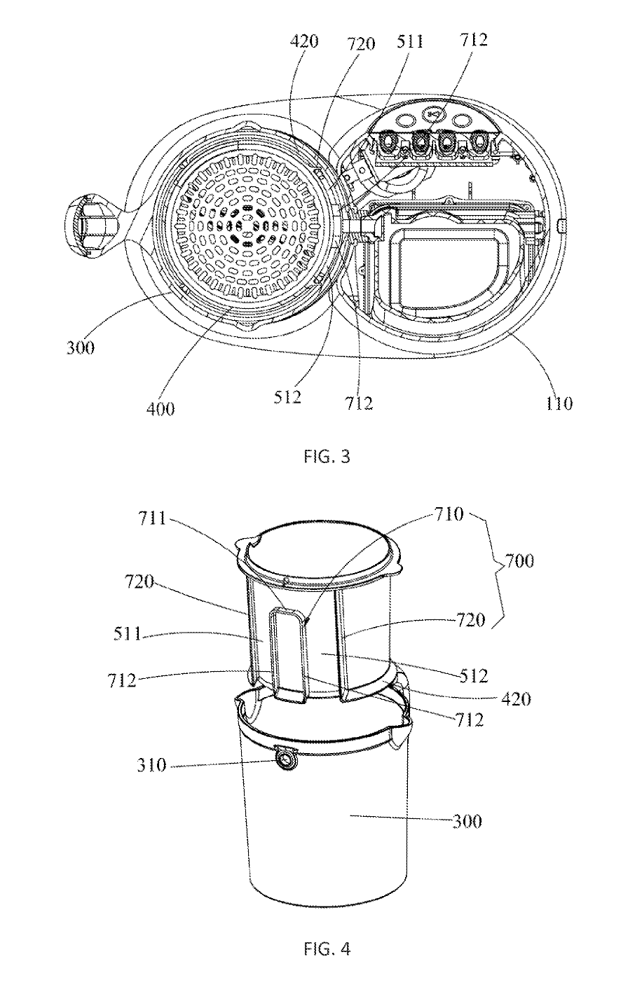

In particular, referring to FIGS. 3 and 4, the steam inflow channel 700 is enclosed by the side walls of the heating cup 300 and the steaming cup 400, a guide rib 710 arranged between the above two side walls and isolation ribs 720 located on both sides of the guide rib 710. Accordingly, a left passage 511 and right passage 512 are formed by the middle guide rib 710 and the two isolation ribs 720 located on both side thereof.

Specifically, the guide rib 710 is inverted U shaped which faces the steam inlet, and the curved top 711 of the guide rib 710 is lower than the steam inlet 410. The steam entering the steam inlet 410 passes through the curved top 711 of the guide rib 710 and distributes evenly onto two branches 712 and goes into the left passage 511 and the right passage 512 simultaneously, wherein the passages 511, 512 are formed by the guide rib 710 and two isolation ribs 720, as shown in FIGS. 3 and 4. According to the present embodiment, the guide rib 710 and the isolation ribs 720 are located on the outer surface of the side wall of the steaming cup 400, it should be noted that, the positions of the guide rib 710 and the isolation ribs 720 are not limited to the above situation, these ribs also can be simultaneously provided on the inner surface of the side wall of the heating cup 300, alternatively, they may be located on the outer surface of the side wall of the steaming cup 400 or on the inner surface of the side wall of the heating cup 300, any arrangement is considered to be within the scope of this application as long as the guide rib 710 and the isolation ribs 720 are located inside the first gap 500 between the heating cup 300 and the steaming cup 400. According to the present embodiment, there is one guide rib 710 and two isolation ribs 720 which are located on both sides of the guide rib 710, of course, the number of the guide rib 710 and the isolation rib 720 is not limited within the situation in this embodiment, it may be more than more than two.

According to this embodiment, the bottom of side wall of the steaming cup 400 comprises a ribbon 420 for separating the first gap 500 from the second gap 600, wherein both ends of the ribbon 420 are connected to the two isolation ribs 720 on both sides of the guide rib 710. By means of the ribbon 420, the steam entering the second gap 600 from the left passage 511 and the right passage 512 is prevented from going into the first gap 500, as a result, the utilization of steam entering the steaming cup 400 is improved on one hand, the effective insulations of the heating cup 300 and the steaming cup 400 are achieved on the other hand, so the burn to a user caused by the heated side wall of the heating cup 300 can be avoided.

According to this embodiment, a top cover 800 is further disposed on the heating cup 300 for avoiding the burn to a user caused by the heat of the steam of the steaming cup 400, in this embodiment the top cover 800 comprises an insulation plate 900 therein.

In particular, a curved convex pad 910 is arranged on the inner side of the top cover 800, and an insulation cavity 810 is formed between the pad 910 and the top cover 800, and the insulation plate 900 is disposed under the pad 910. By means of the double insulation function of the insulation plate 900 and the insulation cavity 810, it is ensured that the top cover 900 will not be heated in use, and the burn to user can be avoided, so this kind of product is more user-friendly.

The embodiments above are merely the preferable embodiments of the present application and not intended to limit the present application. And all changes, equivalent substitution and improvements which come within the meaning and range of equivalency of the present application are intended to be embraced therein.

1. A steam channel structure for food processor, wherein the food processor comprises a processor body, a steam generator arranged inside the processor body, and a heating cup disposed on the processor body, the heating cup has a steam inlet interconnected with the steam generator and a steam outlet,
wherein the steam inlet is disposed on the side wall of the heating cup, the heating cup includes a steaming cup therein, wherein the steaming cup has a gas pore on the bottom wall thereof, a first gap is arranged between the side walls of the steaming cup and the heating cup, a second gap interconnected with the first gap is arranged between the bottom walls of the steaming cup and the heating cup, a steam inflow channel corresponding to the steam inlet is arranged inside the first gap, and the steam distributes on both sides of the steam inlet and flows into the steam inflow channel, and the steam passes through the second gap and flows into the steaming cup through the gas pore.

2. The steam channel structure of claim 1, wherein the steam inflow channel is enclosed by the side wall of the heating cup, the side wall of the steaming cup, a guide rib arranged between the two side walls and isolation ribs located on both sides of the guide rib.

3. The steam channel structure of claim 2, the guide rib faces the steam inlet, the guide rib has a shape of an inverted U which comprises two branches, wherein each of the branches forms with the isolation ribs a left channel and a right channel for steam flow respectively, the top of the guide rib is lower than the steam inlet.

4. The steam channel structure of claim 3, wherein the guide rib is provided on the inner surface of the side wall of the heating cup or on the outer surface of the side wall of the steaming cup, and the isolation rib is arranged on the inner surface of the side wall of the heating cup or on the outer surface of the side wall of the steaming cup.

5. The steam channel structure of claim 2, wherein the bottom of side wall of the steaming cup comprises a ribbon for isolating the first gap from the second gap, wherein both ends of the ribbon are connected to the isolation ribs on both sides of the guide rib.

6. The steam channel structure of claim 1, wherein a lid is arranged on the heating cup and an insulation plate is arranged on the inner side of the lid.

7. The steam channel structure of claim 1, wherein a curved convex pad is arranged on the inner side of the lid, an insulation cavity is formed between the convex pad and the lid, and the insulation plate is disposed under the convex pad.

8. A food processor comprising the steam channel structure of claim 1.

9. A food processor comprising the steam channel structure of claim 2.

10. A food processor comprising the steam channel structure of claim 3.

11. A food processor comprising the steam channel structure of claim 4.

12. A food processor comprising the steam channel structure of claim 5.

13. A food processor comprising the steam channel structure of claim 6.

14. A food processor comprising the steam channel structure of claim 7.
